(19) United States
(12) Patent Application Publication
(10) Pub. No.: US 2015/0072201 A1
(43) Pub. Date: Mar. 12, 2015

(54) CYLINDRICAL SECONDARY BATTERY

(71) Applicants: Osamu Kubota, Tokai (JP); Akihide Tanaka, Mito (JP); Xiaoliang Feng, Mito (JP)

(72) Inventors: Osamu Kubota, Tokai (JP); Akihide Tanaka, Mito (JP); Xiaoliang Feng, Mito (JP)

(73) Assignee: HITACHI, LTD., Tokyo (JP)

(21) Appl. No.: 13/885,085

(22) PCT Filed: Nov. 16, 2010
(86) PCT No.: PCT/JP2010/070376

§ 371 Date: Jul. 24, 2013

(51) Int. Cl. H01M 2/30; H01M 2/02

(52) U.S. Cl. CPC H01M 2/30; H01M 2/022
USPC 429/94

(57) ABSTRACT

A conductive lead 21 or 22 welded to a positive electrode 11 or a negative electrode 12 protrudes from the upper surface side and the lower surface side of an electrode group 10. The conductive leads 21 and 22 have spiral shape portions 21b and 22b and end portions 21c and 22c for welding, respectively. The end portion 21c for welding of the conductive lead 21 is welded to a lid unit 5, and the end portion 22c for welding of the conductive lead 22 is welded to a can bottom 203 of a battery can 2. The end portion 22c for welding of the conductive lead 22 is positioned corresponding to a hollow portion 15a of an axial core 15.

### TECHNICAL FIELD

This invention relates to a cylindrical secondary battery.

### BACKGROUND ART

In cylindrical secondary batteries represented by lithium secondary batteries or the like, a positive electrode and a negative electrode are wound around the periphery of a hollow cylindrical axial core via a separator, thereby forming an electrode group as a power generation element. The electrode group is accommodated in a battery can, and one of the positive electrode and the negative electrode is welded to a can bottom of the battery can serving as an external terminal of one of the positive and negative electrodes, with the other being welded to a lid member serving as an external terminal of reverse polarity. Before being welded to the lid member, an electrolytic solution is injected into the interior of the battery can, the electrode group is welded to the lid member, and the lid member and the battery can are then hermetically sealed from the outside by means of caulking.

In order to weld the positive or negative electrode to the battery can or the lid member, there are a structure using a large number of conductive leads and a structure using a small number of conductive leads as from 1 to 2. The structure using a small number of conductive leads is mainly used for small-sized cylindrical secondary batteries with a low charge and discharge current.

In the cylindrical secondary batteries, since torsion acts on the welded portion between the conductive lead and the battery can or the lid member following expansion and contraction and vibration of the electrode group or displacement thereof into the axial direction, as generated at the time of charge and discharge, breakage is liable to be caused in the welded portion due to the long-term use.

Accordingly, a variety of structures for preventing the breakage of the welded portion have been studied. As an example thereof, there is known a structure in which a conductive lead is provided with a helical shape portion which does not close a gas-removal hole in its central portion (see, for example, PTL 1). The above-described patent literature does not describe a structure of the welded portion of the can bottom side.

### CITATION LIST

### Patent Literature

PTL 1: JP-A-2001-23608

### SUMMARY OF INVENTION

### Technical Problem

In the above-described patent literature, the conductive lead is formed in a spiral shape so as not to close the gas-removal hole in the central portion, and an end portion for welding is welded to the lid member at a position out of the central portion of the axial core. As an example of a method of welding a conductive lead to a can bottom of a battery can, there is known a method in which an electrode rod is inserted into a hollow portion of an axial core, and an end portion for welding of an electrode lead is welded to a tip of the electrode rod by means of, for example, resistance welding or the like in a state of being pressed onto the can bottom of the battery can. The above-described method cannot be applied in the structure in which the end portion for welding of the conductive lead is positioned out of the central portion as in the above-described patent literature. Accordingly, for example, a method with low working efficiency, in which a conductive lead is preliminarily welded to an electrode plate, and the electrode plate is then accommodated together with an electrode group in a battery can, must be adopted.

### Solution to Problem

A cylindrical secondary battery according to a first aspect of the present invention is concerned with a cylindrical secondary battery in which an electrode group having a positive electrode and a negative electrode wound around the periphery of an axial core having a hollow portion via a separator is accommodated in a battery can, and one of a conductive lead welded to the negative electrode and a conductive lead welded to the positive electrode is connected to a lid member covering an opening of the battery can, with the other being welded to a can bottom of the battery can, wherein at least the conductive lead welded to the can bottom of the battery can includes an end portion for welding which is extended to a position corresponding to a central portion of the hollow portion of the axial core and a routing portion which is deformable in the axial direction of the axial core and the perpendicular direction to the axial direction, and the end portion for welding is welded to the can bottom of the battery can.

A cylindrical secondary battery according to a second aspect of the invention is concerned with the cylindrical secondary battery according to claim 1, wherein the routing portion of the conductive lead is routed around the periphery of the end portion for welding from the end portion for welding so as not to overlap planarly.

A cylindrical secondary battery according to a third aspect of the invention is concerned with the cylindrical secondary battery according to claim 1 or 2, wherein the conductive lead includes a bending portion for bending the routing portion toward the outer periphery side in at least one place between the end portion for welding and the routing portion.

A cylindrical secondary battery according to a fourth aspect of the invention is concerned with the cylindrical secondary battery according to any one of claims 1 to 3, wherein the routing portion of the conductive lead is in a spiral shape.

A cylindrical secondary battery according to a fifth aspect of the invention is concerned with the cylindrical secondary battery according to any one of claims 1 to 4, wherein the conductive lead welded to the can bottom of the battery can is welded to the positive electrode or the negative electrode in a side edge on the winding start side of the axial core of the positive electrode or the negative electrode.

A cylindrical secondary battery according to a sixth aspect of the invention is concerned with the cylindrical secondary battery according to claim 5, further including an insulating sheet disposed between the conductive lead and the can bottom of the battery can, the insulating sheet including a slit for inserting thereinto an opening corresponding to the hollow portion of the axial core and the conductive lead of the axial core.

A cylindrical secondary battery according to a seventh aspect of the invention is concerned with the cylindrical secondary battery according to anyone of claims 1 to 4, wherein the conductive lead including the end portion for welding welded to the can bottom of the battery can is welded to the positive electrode or the negative electrode in an intermediate portion in the lengthwise direction in the positive electrode or the negative electrode.

A cylindrical secondary battery according to an eighth aspect of the invention is concerned with the cylindrical secondary battery according to claim 7, further including an insulating sheet disposed between the conductive lead and the can bottom of the battery can, the insulating sheet including a first opening provided at a position corresponding to the hollow portion of the axial core, a second opening provided at a position corresponding to a root of the conductive lead in which the conductive lead is welded to the positive electrode or the negative electrode, and a slit for inserting thereinto the conductive lead which is lead out from the second opening into the outside.

A cylindrical secondary battery according to a ninth aspect of the invention is concerned with the cylindrical secondary battery according to anyone of claims 1 to 8, wherein all of the conductive leads include a routing portion which is deformable in the axial direction of the axial core and the perpendicular direction to the axial direction.

A cylindrical secondary battery according to a tenth aspect of the invention is concerned with the cylindrical secondary battery according to anyone of claims 1 to 9, wherein a welded portion between the end portion for welding and the can bottom of the battery can has a size of from 1 to 5 mm in terms of a radius.

### Advantageous Effects of Invention

Since the conductive lead is deformable in the axial direction of the axial core and the perpendicular direction to the axial direction, the breakage of the welded portion can be prevented. In addition, since the end portion for welding is extended to a position corresponding to a central portion of the hollow portion of the axial core, by inserting an electrode rod into the hollow portion of the axial core, it is possible to weld the end portion for welding directly to the can bottom of the battery can.

### BRIEF DESCRIPTION OF DRAWINGS

FIG. 1 is a cross-sectional view of an embodiment of a cylindrical secondary battery according to the invention.

FIG. 2 is an exploded perspective view of the cylindrical secondary battery illustrated in FIG. 1.

FIG. 3 is a perspective view showing a state before bending a conductive lead of an electrode group illustrated in FIG. 2.

FIG. 4 is a perspective view of a state where a part of the electrode group illustrated in FIG. 3 is developed.

FIG. 5 is a plan view showing a connection state between a positive electrode and a conductive lead.

FIG. 6 is a plan view showing a connection state between a negative electrode and a conductive lead.

FIG. 7 is a perspective view for explaining a method of installing an insulating sheet in an electrode group.

FIG. 8 is a perspective view for explaining a structure of a conductive lead of an electrode group.

FIG. 9 is a view for explaining a detailed structure of a state where a conductive lead is bent, in which (A) is a perspective view, and (B) is a side view.

FIG. 10 is a cross-sectional view for explaining a method of welding a conductive lead to a battery can.

FIG. 11 is a table showing results of a torsion test.

FIG. 12 is a table showing results of a vibration test.

FIG. 13 is a cross-sectional view of Embodiment 2 of a cylindrical secondary battery according to the present invention.

FIG. 14 is a perspective view for explaining a method of installing an insulating sheet in an electrode group shown in FIG. 13.

FIG. 15 is a plan view showing a connection state between a positive electrode and a conductive lead as illustrated in FIG. 14.

FIG. 16 is a plan view showing a connection state between a negative electrode and a conductive lead as illustrated in FIG. 14.

### DESCRIPTION OF EMBODIMENTS

### Embodiment 1

The cylindrical secondary battery according to the invention is hereunder described by reference to a lithium ion cylindrical secondary battery as an embodiment together with the drawings.

### (Entire Configuration of Secondary Battery)

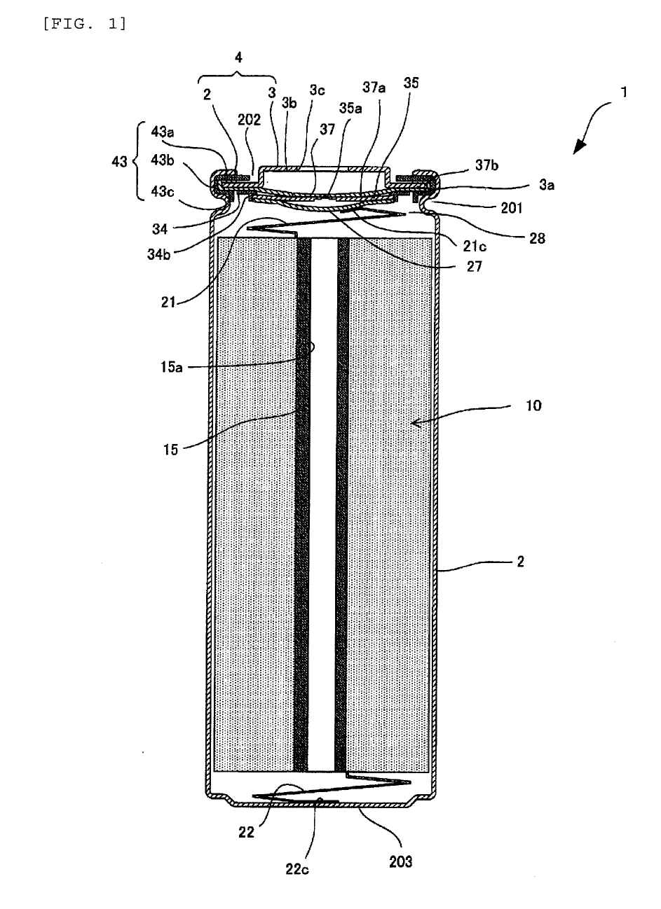

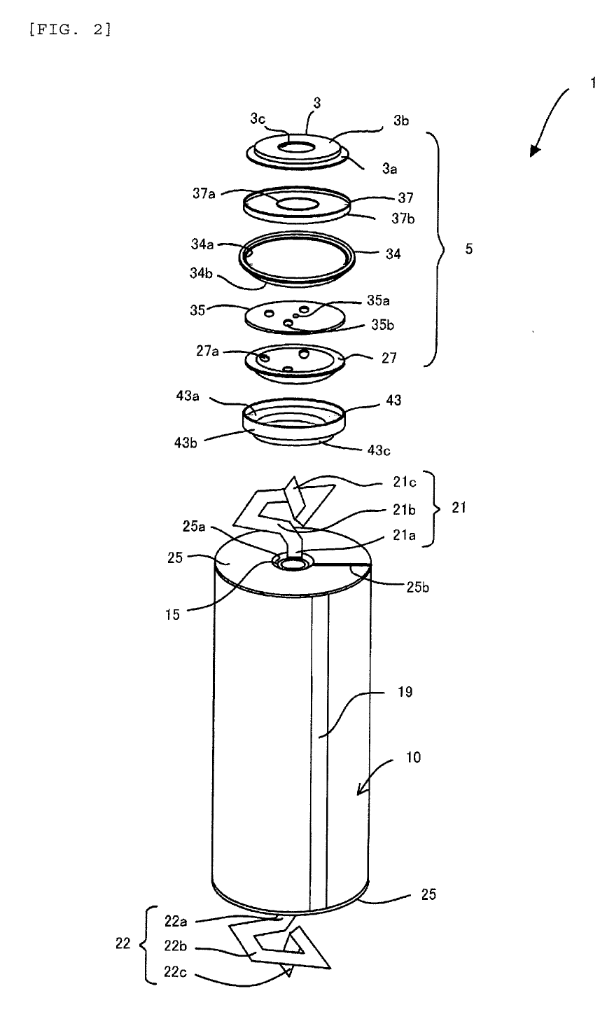

FIG. 1 is a cross-sectional view of a cylindrical secondary battery according to the invention, and FIG. 2 is an exploded perspective view of the cylindrical secondary battery shown in FIG. 1. However, in FIG. 2, illustration of the battery can illustrated in FIG. 1 is omitted.

A cylindrical secondary battery 1 has dimensions of an external shape of from about 14 to 26 mmφ and a height of from about 43 to 65 mm.

This cylindrical secondary battery 1 has a battery container 4 having a structure in which a closed-end cylindrical battery can 2 and a hat shaped lid body 3 are subjected to caulking processing via a seal member 43 generally called a gasket and hermetically sealed from the outside. The closed-end cylindrical battery can 2 is formed by subjecting a metal plate made of iron, aluminum, stainless steel, or the like to press processing, and in the case of an iron-made plate, for the purpose of preventing corrosion, a plated film of nickel or the like is formed over the entirety of the outer and inner surfaces thereof. The battery can 2 has an opening 202 on the upper end side that is an open side thereof. A groove 201 protruding inside the battery can 2 is formed on the side of the opening 202 of the battery can 2. Respective constituent members for the power generation as described below are accommodated in the interior of the battery can 2.

Reference numeral 10 stands for an electrode group which has an axial core 15 in its central portion, and a positive electrode and a negative electrode are wound around the periphery of the axial core 15. The axial core 15 has a hollow cylindrical shape having a hollow portion 15a in the center thereof.

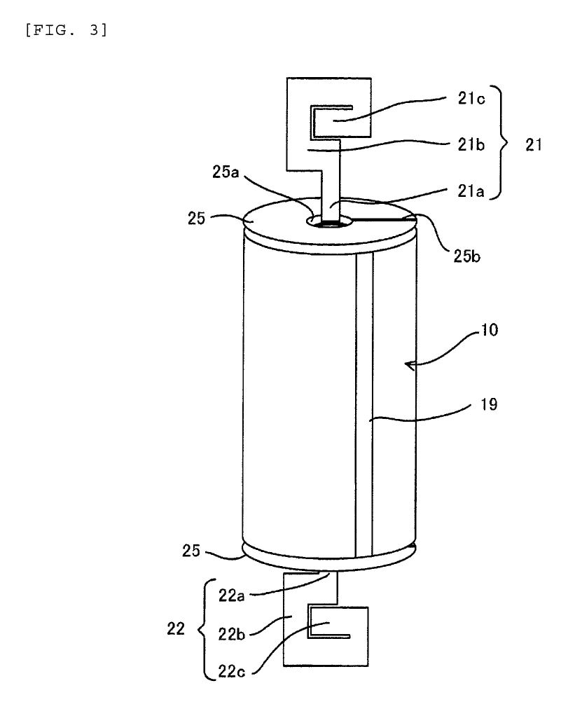

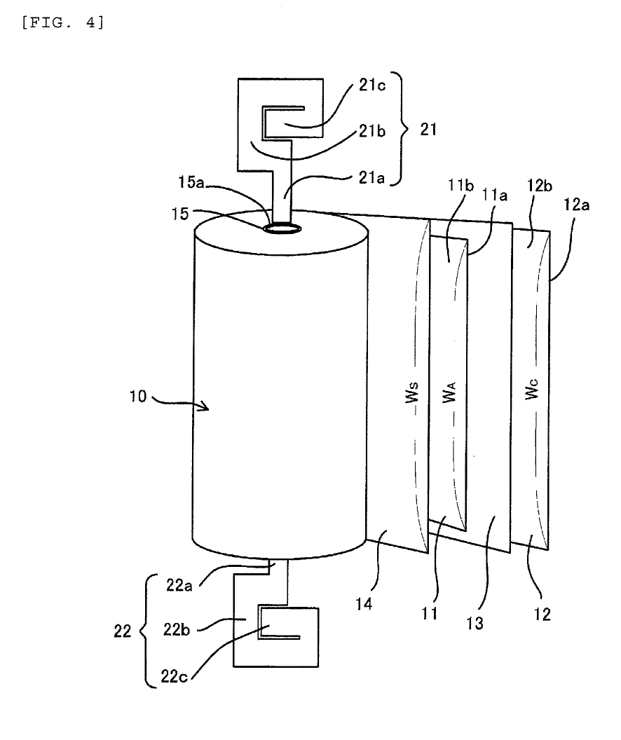

FIG. 3 is a perspective view showing a state before bending a conductive lead of the electrode group illustrated in FIG. 2, and FIG. 4 is a perspective view in which a part of the electrode group illustrated in FIG. 3 is developed. However, in FIG. 4, illustration of an insulating sheet (details of which will be described later) in FIG. 3 is omitted.

As illustrated in FIG. 4, the electrode group 10 has a structure in which a positive electrode 11, a negative electrode 12, and first and second separators 13 and 14 are wound around the periphery of the axial core 15.

The axial core 15 has a hollow cylindrical shape, and the negative electrode 12, the first separator 13, the positive electrode 11, and the second separator 14 are laminated in this order and wound on the axial core 15. Inside the innermost peripheral negative electrode 12, the first separator 13 and the second separator 14 are wound by several turns. In addition, the negative electrode 12 and the second separator 14 wound on the outer periphery thereof appear on the outermost periphery. The second separator 14 on the outermost periphery is held down with an adhesive tape 19, for example, KAPTON (registered trademark) tape or the like (see FIGS. 2 and 3).

A conductive lead 21 of the positive electrode side is welded to the positive electrode 11, and a conductive lead 22 of the negative electrode side is welded to the negative electrode 12.

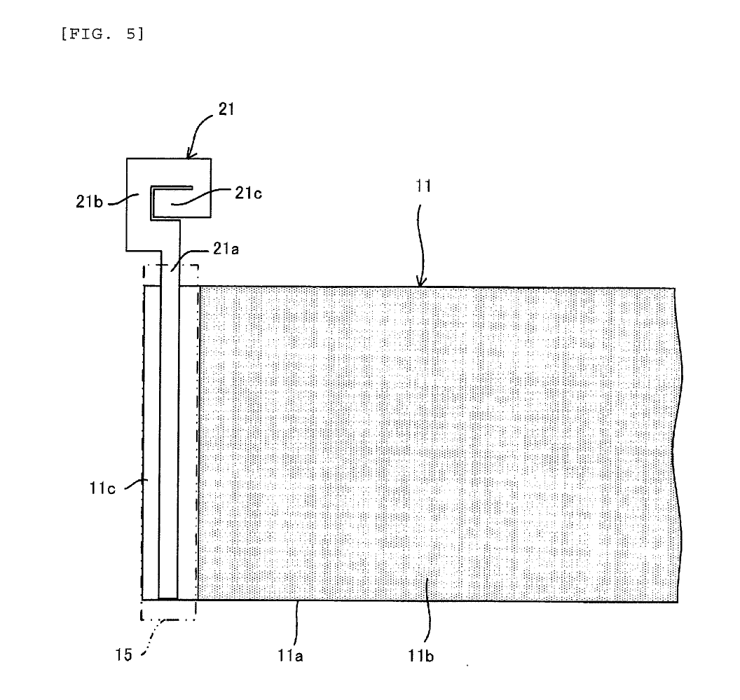

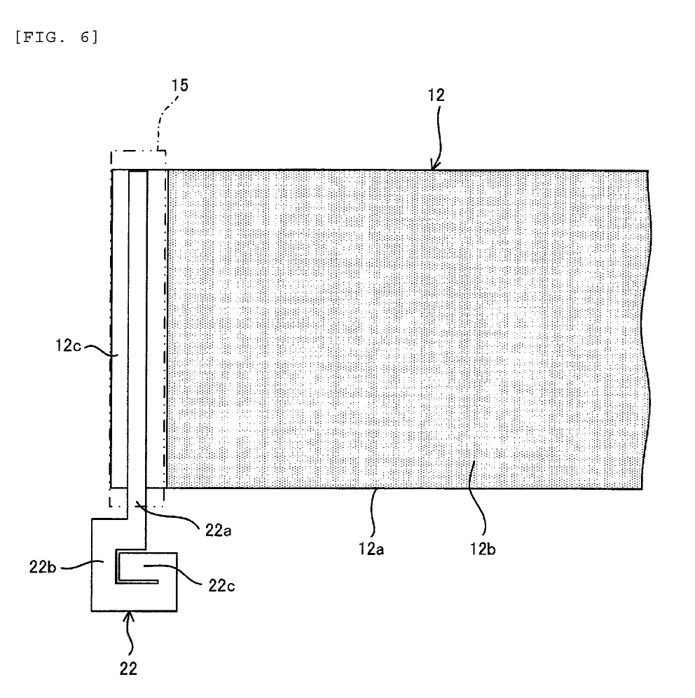

FIG. 5 is a plan view showing a connection state between the positive electrode 11 and the conductive lead 21 of the positive electrode side, and FIG. 6 is a plan view showing a connection state between the negative electrode 12 and the conductive lead 22 of the negative electrode side.

As illustrated in FIG. 5, the positive electrode 11 has a positive electrode sheet 11a having a longitudinal shape, which is formed of an aluminum foil, and a positive electrode mixture 11b is coated and formed on the both surfaces of this positive electrode sheet 11a (in FIG. 5, only one surface of the positive electrode sheet 11a is illustrated). A side edge in the axial direction on the winding start side of the axial core 15 (described by a two-dotted chain line in FIG. 5) of the positive electrode sheet 11a is a positive electrode mixture-untreated portion 11c in which the aluminum foil is exposed without being coated with the positive electrode mixture 11b. The positive electrode mixture 11b is coated over the entirety of the positive electrode sheet 11a exclusive of the positive electrode mixture-untreated portion 11c, and a width of the positive electrode sheet 11a and a width of the positive electrode mixture 11b are equal to each other. The conductive lead 21 of the positive electrode side, which protrudes upward in parallel to the axial core 15 and which is formed of an aluminum foil, is welded to the positive electrode mixture-untreated portion 11c. Welding between the positive electrode sheet 11a and the conductive lead 21 of the positive electrode side is performed by means of, for example, resistance welding.

An example of the formation method of the positive electrode 11 is hereunder shown.

LiNi_{0.33}Mn_{0.33}Co_{0.33}O₂ as a positive electrode active material, powdered carbon as a conductive agent, and polyvinylidene fluoride (PVDF) as a binder are weighed in a weight ratio of 85/10/5, to which is then added an appropriate amount of N-methylpyrrolidone (NMP) as a solvent, and these are kneaded for 30 minutes using a kneader, thereby obtaining a positive electrode slurry. Examples of a method of coating the positive electrode slurry on the positive electrode sheet 11a include a roll coating method, a slit die coating method, and the like. This positive electrode slurry is coated on the both surfaces of the positive electrode sheet 11a made of an aluminum foil (thickness: 20 μm, width: 56 mm). An example of the coating thickness of the positive electrode slurry is about 40 μm per one side. Thereafter, the positive electrode sheet 11a is subjected to rolling molding under a load of from 13 tons to 14 tons using a press machine, followed by vacuum drying at 120° C. for 3 hours.

As illustrated in FIG. 6, the negative electrode 12 has a negative electrode sheet 12a having a longitudinal shape, which is formed of a copper foil, and a negative electrode mixture 12b is coated and formed on the both surfaces of this negative electrode sheet 12a (in FIG. 6, only one surface of the negative electrode sheet 12a is illustrated). A side edge in the axial direction on the winding start side of the axial core 15 (described by a two-dotted chain line in FIG. 6) of the negative electrode sheet 12a is a negative electrode mixture-untreated portion 12c in which the copper foil is exposed without being coated with the negative electrode mixture 12b. The negative electrode mixture 12b is coated over the entirety of the negative electrode sheet 12a exclusive of the negative electrode mixture-untreated portion 12c, and a width of the negative electrode sheet 12a and a width of the negative electrode mixture 12b are equal to each other. The conductive lead 22 of the negative electrode side, which protrudes upward in parallel to the axial core 15 and which is formed of a nickel foil, is welded to the negative electrode mixture-untreated portion 12c. Welding between the negative electrode sheet 12a and the conductive lead 22 of the negative electrode side is performed by means of, for example, resistance welding.

An example of the formation method of the negative electrode 12 is hereunder shown.

Natural graphite as a negative electrode active material, powdered carbon as a conductive agent, and PVDF as a binder are weighed in a weight ratio of the negative electrode active material to the conductive agent to the binder of 90/5/5, to which is then added an appropriate amount of N-methylpyrrolidone (NMP) as a solvent, and these are kneaded for 30 minutes using a kneader, thereby obtaining a negative electrode slurry. The obtained negative electrode slurry is coated on the both surfaces of the negative electrode sheet 12a made of a copper foil having a thickness of 10 μm (thickness: 10 μm, width: 57 mm). Examples of a method of coating the negative electrode slurry on the negative electrode sheet 12a include a method of coating a dispersion solution of constituent materials of the negative electrode slurry on the negative electrode sheet 12a. Examples of the coating method include a roll coating method, a slit die coating method, and the like. Thereafter, the sheet is subjected to rolling molding under a load of from 13 tons to 14 tons using a press machine, followed by vacuum drying at 120° C. for 3 hours. An example of the coating thickness of the negative electrode slurry is about 40 μm per one side.

As illustrated in FIG. 4, a width W_{C} of the negative electrode mixture 12b which is formed on the negative electrode sheet 12a is made larger than a width W_{A} of the positive electrode mixture 11b which is formed on the positive electrode sheet 11a. In addition, a width W_{S} of each of the first separator 13 and the second separator 14 is made larger than the width W_{C} of the negative electrode mixture 12b which is formed on the negative electrode sheet 12a.

Namely, there is a relation of W_{A}<W_{C}<W_{S}.

In view of the fact that the width W_{C} of the negative electrode mixture 12b is larger than the width W_{A} of the positive electrode mixture 11b, an internal short circuit to be caused due to deposition of extraneous materials is prevented. This is because in the case of a lithium ion secondary battery, lithium that is a positive electrode active material is ionized to permeate the separator; however, if a negative electrode active material is not formed on the negative electrode side, and the negative electrode sheet 12a is exposed, lithium is deposited on the negative electrode sheet 12a, thereby causing the generation of an internal short circuit.

The first and second separators 13 and 14 are, for example, a polyethylene-made porous film having a thickness of 40 μm.

The conductive lead 21 of the positive electrode side is disposed so as to come into contact with the outer periphery of the axial core 15 via the side edge on the winding start side of each of the first and second separators 13 and 14 and protrudes into the upper side of the electrode group 10. The conductive lead 22 of the negative electrode side is disposed so as to come into contact with the outer periphery of the axial core 15 via the side edge on the winding start side of each of the first and second separators 13 and 14 and protrudes into the lower side of the electrode group 10. The conductive lead 21 of the positive electrode side has a spiral shape portion (routing portion) 21b which is bent from a main body portion 21a welded to the positive electrode sheet 11a. The conductive lead 22 of the negative electrode side has a spiral shape portion (routing portion) 22b which is bent from a main body portion 22a welded to the negative electrode sheet 12a. Though details of each of the spiral shape portions 21b and 22b are described later, its tip portion constitutes end portions 21c and 22c for welding, respectively, each of which is extended to a position corresponding to the hollow portion 15a of the axial core 15.

On each of the upper surface side and the lower surface side of the electrode group 10, an insulating sheet 25 (see FIG. 2) having an opening 25a having a diameter slightly larger than the outer periphery of the axial core 15 is disposed at a position corresponding to the axial core 15. A slit 25b reaching the opening 25a from the outer periphery is formed on the insulating sheet 25.

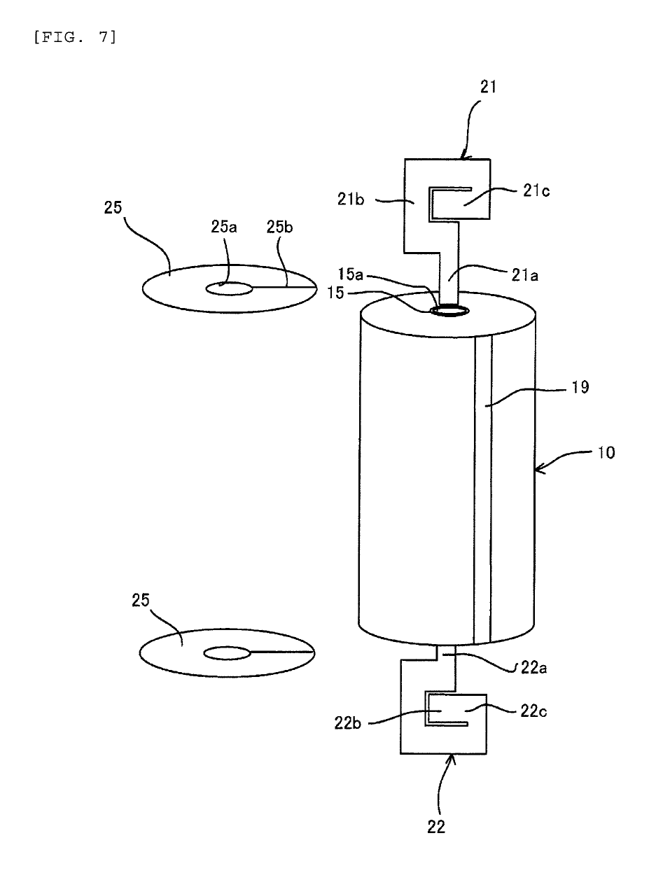

FIG. 7 is a perspective view showing a state before installing the respective insulating sheets 25 to the electrode group 10.

In order to install the insulating sheet 25, the slit 25b is registered with the main body portion 21a or 22a of the respective conductive lead 21 or 22 of the positive or negative electrode side. Then, in FIG. 7, the insulating sheet 25 is moved in the horizontal direction, thereby accommodating the main body portion 21a or 22a of the conductive lead 21 or 22 within the opening 25a. A radius of the opening 25a of the insulating sheet 25 is made slightly larger than a radius of from the center of the axial core 15 to the position of the main body part 21a or 22a of the conductive lead 21 or 22. Accordingly, the insulating sheet 25 is made coaxial with the axial core 15 in a state where the main body portions 21a or 22a of the respective conductive lead 21 or 22 is disposed within the opening 25a of the insulating sheet 25. In this state, the outer periphery of the insulating sheet 25 is made to have a size such that it is positioned on substantially the same plane as the outer periphery of the electrode group 10 or slightly inward relative to the outer periphery of the electrode group 10.

A lid unit 5 (see FIG. 2) is disposed in an upper portion of the conductive lead 21 of the positive electrode side. The lid unit 5 is configured of a collector plate 27, an insulating plate 34, a connection plate 35, a diaphragm 37, and a lid body 3.

The collector plate 27 is formed of, for example, aluminum and has a dish-like shape in which a center side thereof protrudes toward the side of the electrode group 10. The end portion 21c for welding of the conductive lead 21 of the positive electrode side is welded to the lower surface of the collector plate 27 by means of ultrasonic welding or spot welding. The conductive lead 21 and the collector plate 27 are welded to each other at a position of the outside of the radial direction of the hollow portion 15a of the axial core (see FIG. 1). However, as described later, the welded portion between the conductive lead 21 and the collector plate 27 may also be a position corresponding to the hollow portion 15a of the axial core 15. In the collector plate 27, a plurality of openings 27a (see FIG. 2) for releasing a gas generated in the interior of the battery are formed.

Since the collector plate 27 is oxidized by an electrolytic solution, its reliability can be enhanced by forming it with aluminum. As for aluminum, when its surface is exposed by some kind of processing, an aluminum oxide film is immediately formed on the surface, and the oxidation by the electrolytic solution can be prevented due to this aluminum oxide film.

The insulating plate 34 has an annular shape formed of an insulating resin material. The insulating plate 34 has an opening 34a (see FIG. 2) and a side portion 34b protruding downward. In the inside of the opening 34a of the insulating material 34, the collector plate 27 and the connection plate 35 are brought into contact with each other in terms of peripheral portions thereof and engaged in an electrically connected state.

The connection plate 35 is formed of an aluminum alloy and has a substantially dish-like shape in which substantially the entirety exclusive of the central portion is uniform, and the center side is slightly bent at a low position. A thickness of the connection plate 35 is, for example, about 1 mm. A thin-walled protruding portion 35a formed in a dome shape is formed in the center of the connection plate 35, and a plurality of openings 35b (see FIG. 2) are formed on the periphery of the protruding portion 35a. The openings 35b are formed for the purpose of releasing a gas generated in the interior of the battery.

The protruding portion 35a of the connection plate 35 is welded to the bottom surface of the central portion of the diaphragm 37 by means of resistance welding or friction stir welding. The diaphragm 37 is formed of an aluminum alloy and has a circular notch 37a centering on a central portion of the diaphragm 37. The notch 37a is one in which its upper surface side is crushed in a V shape by means of pressing, with the remainder being made thin in wall thickness.

The diaphragm 37 is provided for the purpose of ensuring the safety of the battery. When the internal pressure of the battery increases, in a first stage, the diaphragm 37 bends upward to detach the junction to the protruding portion 35a of the connection plate 35 so that it separates from the connection plate 35, thereby breaking the electrical continuity with the connection plate 35. In a second stage, in the case where the internal pressure still increases, the diaphragm 37 ruptures in the notch 37a to function to release the gas in the inside.

In a peripheral portion of the diaphragm 37, it is fixed to a peripheral portion 3a of the lid body 3. As illustrated in FIG. 2, in the peripheral portion of the diaphragm 37, it has a side portion 37b which initially stands up vertically toward the side of the lid body 3. The lid body 3 is accommodated within this side portion 37b, and the side portion 37b is bent and fixed to the upper surface side of the lid body 3 by means of caulking processing.

The lid body 3 is formed of iron such as carbon steel, and a plated film of nickel or the like is formed over the entirety of the outer and inner surfaces thereof. The lid body 3 has a hat shape having the disk-shaped peripheral portion 3a coming into contact with the diaphragm 37 and a headed, bottomless cylindrical portion 3b which protrudes upward from this peripheral portion 3a. An opening 3c is formed in the cylindrical portion 3b. This opening 3c is formed for allowing a gas which has been generated in the interior of the battery to release outside the battery at the time of rupture of the diaphragm 37 due to the gas pressure.

Incidentally, in the case where the lid body 3 is formed of iron, at the time of joining with another cylindrical secondary battery in series, it is possible to join with another cylindrical secondary battery formed of iron by means of spot welding.

The lid body 3, the diaphragm 37, the insulating plate 34, the connection plate 35, and the collector plate 27 are integrated to configure the lid unit 5. A method of assembling the lid unit 5 is hereunder shown.

First of all, the lid body 3 is fixed to the diaphragm 37. The fixation of the lid body 3 to the diaphragm 37 is performed by means of caulking or the like. As illustrated in FIG. 2, since the side wall 37b of the diaphragm 37 is initially formed vertically to the base portion 37a, the peripheral portion 3a of the lid body 3 is disposed within the side wall 37b of the diaphragm 37. Then, the side wall 37b of the diaphragm 37 is deformed by means of pressing or the like, so that it is brought into press contact with the upper and lower surfaces of the peripheral portion of the lid body 3 and also the outer peripheral side surface and covers them.

On the other hand, the connection plate 35 is engaged and installed in the opening 34a of the insulating plate 34. Subsequently, the protruding portion 35a of the connection plate 35 is welded to the bottom surface of the diaphragm 37 to which the lid body 3 is fixed, in a state of interposing the insulating plate 34 therebetween. In that case, as for the welding method, resistance welding or friction stir welding can be adopted. Subsequently, the collector plate 27 is engaged in the opening 34a of the insulating plate 34 and held by the insulating plate 34 in a state of bringing the peripheral portion into contact with the connection plate 35. The collector plate 27 and the connection plate 35 may be welded to each other as the need arises. In this way, the diaphragm 37 is caulked with the lid body 3, the connection plate 35 is welded to the diaphragm 37, the insulating plate 34 is held by the connection plate 35, and the collector plate 27 is held by the insulating plate 34, whereby the lid unit 5 is configured.

As described above, the lid body 3 of the lid unit 5 is connected to the positive electrode 11 via the conductive lead 21 of the positive electrode side, the collector plate 27, the connection plate 35, and the diaphragm 37. The lid body 3 connected to the positive electrode 11 in this way acts as an external terminal of one side.

The seal member 43 which is generally called a gasket is provided so as to cover the peripheral portion of the side portion 37b of the diaphragm 37. The seal member 43 is formed of rubber. While it is not intended to limit the seal member 43, as one of preferred examples thereof, there can be exemplified an ethylene propylene copolymer (EPDM). A thickness of the seal member 43 is about 1.0 mm.

Initially, as illustrated in FIG. 2, the seal member 43 has a shape including an outer peripheral wall portion 43b formed on the peripheral side edge of an annular base portion 43a so as to standup substantially vertically toward the upper direction, and a cylindrical portion 43c formed on the inner peripheral side of the annular base portion 43a so as to hang down substantially vertically toward the lower direction.

Then, caulking processing is performed by bending the outer peripheral wall portion 43b of the seal member 43 together with battery can 2 by means of pressing or the like, thereby bringing the diaphragm 37 and the lid body 3 into press contact with each other in the axial direction by the base portion 43a and the outer peripheral wall portion 43b. According to this, the lid unit 5 in which the lid body 3, the diaphragm 37, the insulating plate 34, the connection plate 35, and the collector plate 27 are integrally formed is fixed to the battery can 2 via the seal member 43.

The conductive lead 22 of the negative electrode side has the end portion 22c for welding which is extended to the central portion of the hollow portion 15a of the axial core 15. As illustrated in FIG. 1, the end portion 22c for welding is welded to a can bottom 203 of the battery can 2 by means of resistance welding or the like (see FIG. 1).

The battery can 2 connected to the negative electrode 12 by the conductive lead 22 of the negative electrode side acts as an external terminal of the other side. It becomes possible to discharge an electric power stored in the electrode group 10 and charge it in the electrode group 10 by the lid body 3 functioning as an external termination with polarity of one side and the battery can 2 functioning as an external terminal of polarity of the other side.

A prescribed amount of a nonaqueous electrolytic solution is injected into the interior of the battery can 2. It is preferable to use a solution of a lithium salt dissolved in a carbonate-based solvent as an example of the nonaqueous electrolytic solution. Examples of the lithium salt include lithium fluorophosphate (LiPF₆), lithium fluoroborate (LiBF₄), and the like. In addition, examples of the carbonate-based solvent include ethylene carbonate (EC), dimethyl carbonate (DMC), propylene carbonate (PC), methyl ethyl carbonate (MEC), and mixtures with a solvent selected from one or more kinds of the above-described solvents.

### (Structure of Conductive Lead)

Next, detailed structures of the conductive leads 21 and 22 of the positive electrode side and the negative electrode side are described.

The conductive lead 21 of the positive electrode side and the conductive lead 22 of the negative electrode side are the same as each other, except that the positions of the end portions 21c and 22c for welding are different from each other.

Then, the conductive lead 22 of the negative electrode side is described, and thereafter, the difference of the conductive lead 21 of the positive electrode side from the conductive lead 22 of the negative electrode side is described.

As illustrated in FIG. 6, the conductive lead 22 is initially formed in a shape by pressing a nickel foil to have the spiral shape portion 22b in one end side (lower end side in FIG. 6) of the main body portion 22a. The spiral shape as referred to in the present description is defined as a shape which is spirally expanded and routed from the central portion toward the foot side and which does not have portions overlapping each other in the planar view. Since the spiral shape portion 22b having such a spiral shape is a shape which does not have portions overlapping each other in the planar view, it can be efficiently formed by means of pressing.

The tip portion of the spiral shape portion 22b has the end portion 22c for welding positioned on the central axis of the main body portion 22a. The main body portion 22a of the conductive lead 22 is welded to the negative electrode mixture-untreated portion 12c of the negative electrode sheet 12, and thereafter, the negative electrode sheet 12a is wound around the outer periphery of the axial core 15. Then, the electrode group 10 is formed, and thereafter, bending is performed between the main body portion 22a and the spiral shape portion 22b.

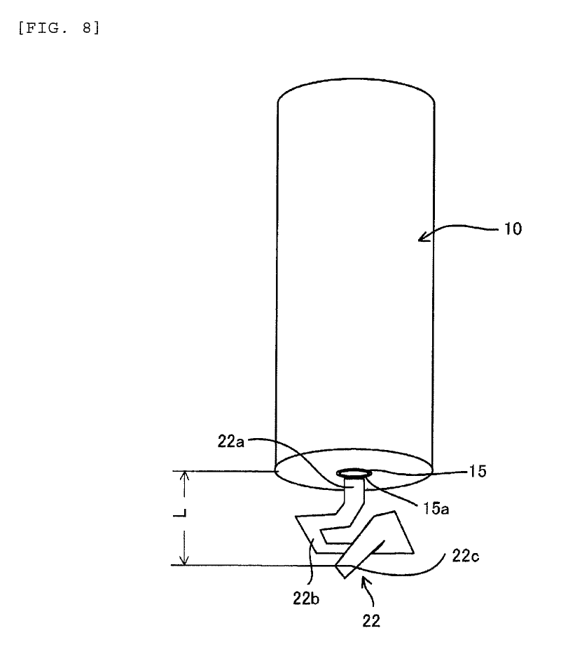

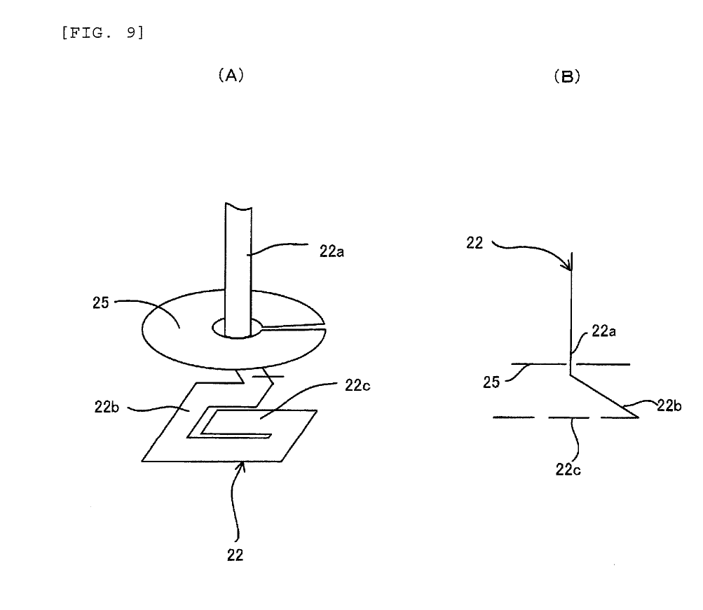

FIG. 8 is a perspective view for explaining the structure of the conductive lead of the electrode group illustrated in FIG. 1; and FIG. 9(A) is a perspective view for explaining the detailed structure of a state where the conductive lead is bent, and FIG. 9(B) is a side view thereof.

The conductive lead 22 is bent toward the outside of the electrode group 10 in the vicinity of the main body portion 22a which is positioned in the vicinity of the outer periphery of the axial core 15 and protrudes from the negative electrode sheet 12a (see also FIG. 1). Then, the conductive lead 22 is bent toward the center side of the electrode group 10 at a position at which the outer peripheral portion of the spiral shape portion 22b is coincident with the outer peripheral portion of the electrode group 10. According to this, the end portion 22c for welding of the tip side of the conductive lead 22 becomes substantially coaxial with the axial core 15 of the electrode group 10. Then, by drawing the tip side of the conductive lead 22 to the direction separated from the electrode group 10, the conductive lead 22 is deformed such that the whole of the spiral shape portion 22b is inclined at substantially the same angle, as also shown in FIG. 1.

As an example, in FIG. 8, as for the conductive lead 22, a length L of from a lower end surface of the electrode group 10 to the end portion 22c for welding is from about 25 to 35 mm.

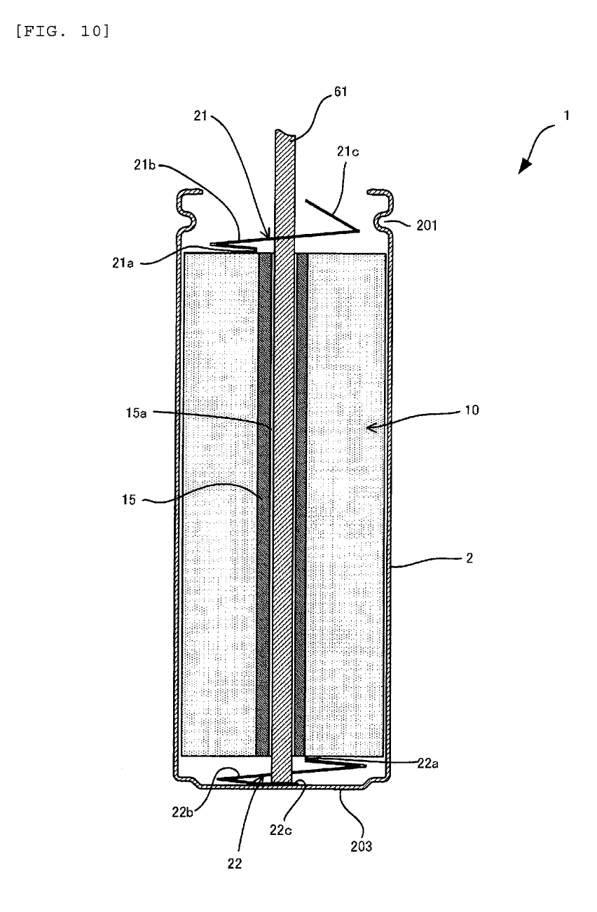

FIG. 10 is a cross-sectional view showing a state where the conductive lead 22 of the negative electrode side is welded to the can bottom 203 of the battery can 2.

The electrode group 10 is accommodated within the battery can 2, and an electrode rod 61 is inserted into the hollow portion 15a of the axial core 15.

In this state, the end portion 21c for welding of the tip side of the conductive lead 21 of the positive electrode side is positioned outside the hollow portion 15a of the axial core 15. When the electrode group 10 is accommodated within the battery can 2, the end portion 22c for welding of the conductive lead 22 of the negative electrode side is disposed at a position corresponding to the hollow portion 15a of the axial core 15. Then, by pressing the end portion 22c for welding of the conductive lead 22 against the inner surface of the can bottom 203 of the battery can 2 in the tip portion of the electrode rod 61, the conductive lead 22 can be welded to the can bottom 203 in this state.

In this way, according to the present embodiment, the conductive lead 22 can be welded directly to the battery can 2 by the electrode rod 61 by merely accommodating the electrode group 10 within the battery can 2. Accordingly, the workability can be significantly enhanced.

In the cylindrical secondary battery, the electrode group 10 expands and contracts in the radial direction at the time of charge and discharge. In addition, the electrode group 10 is displaced in the axial direction due to vibration or the like. Accordingly, torsion acts in the welded portion where the conductive lead 22 and the can bottom 203 of the battery can 2 are welded to each other, and breakage is liable to be generated in the welded portion due to the long-term use.

However, according to the present embodiment, the conductive lead 22 expands and contracts in the axial direction against the displacement of the electrode group 10 in the axial direction. In addition, the conductive lead 22 expands and contracts in the radial direction against the torsion to be caused following the rotation of the electrode group 10 in the circumferential direction. According to this, it is possible to reduce an external force acting in the welded portion between the end portion 22c for welding of the conductive lead 22 and the can bottom 203 of the battery can 2, thereby preventing the breakage of the welded portion.

As for the conductive lead 21 of the positive electrode side, the end portion 21c for welding of the tip side is not positioned on the axial center of the electrode group 10, and as illustrated in FIG. 1, the conductive lead 21 is welded to the collector plate 27 of the lid unit 5 in the outside of the radial direction of the hollow portion 15a of the axial core 15. However, it is possible to easily deform the conductive lead 21. Then, as shown in FIG. 10, since the electrode rod 61 can be inserted into the hollow portion 15a of the axial core 15 by temporarily deforming the conductive lead 21 outside the hollow portion 15a of the axial core 15, as described above, the end portion 21c for welding of the conductive lead 21 of the positive electrode side may be disposed on the axial center of the hollow portion 15a of the axial core 15.

In any way, since the conductive lead 21 of the positive electrode side expands and contracts in the axial direction against the displacement in the axial direction of the electrode group 10 and also expands and contracts in the radial direction against the torsion to be caused following the rotation of the electrode group 10 in the circumferential direction, similar to the conductive lead 22 of the negative electrode side, the conductive lead 21 has an action to prevent the breakage of the welded portion.

### (Manufacturing Method of Cylindrical Secondary Battery)

A manufacturing method of the cylindrical secondary battery shown as the embodiment of the invention is hereunder described.

### [Fabrication of Electrode Group]

First of all, the electrode group 10 is fabricated. The positive electrode 11 in which the positive electrode mixture 11b is coated on the both surfaces of the positive electrode sheet 11a exclusive of the positive electrode mixture-untreated portion 11c is fabricated. In addition, the positive electrode 11 in which the negative electrode mixture 12b is coated on the both surfaces of the negative electrode sheet 12a exclusive of the negative electrode mixture-untreated portion 12c is fabricated.

The main body portion 21a of the conductive lead 21 of the positive electrode side is welded to the positive electrode mixture-untreated portion 11c, thereby fabricating the positive electrode 11 having the conductive lead 21 joined therewith as illustrated in FIG. 5. In addition, the main body portion 22a of the conductive lead 22 of the negative electrode side is welded to the negative electrode mixture-untreated portion 12c, thereby fabricating the negative electrode 12 having the conductive lead 22 joined therewith as illustrated in FIG. 6.

Subsequently, the innermost side edge portions of the first separator 13 and the second separator 14 are welded to the axial core 15. Subsequently, the first separator 13 and the second separator 14 are wound by one to several turns around the axial core 15, the negative electrode 12 is interposed between the second separator 14 and the first separator 13, and the axial core 15 is wound at a prescribed angle. Subsequently, the positive electrode 11 is interposed between the first separator 13 and the second separator 14. Then, in this state, the resultant is wound by prescribed turns, thereby fabricating the electrode group 10.

Subsequently, as illustrated in FIG. 7, the slit 25b of the insulating sheet 25 is inserted into the root portions of the main body portions 21a and 22a of the conductive leads 21 and 22 protruding from the upper and lower surfaces of the electrode group 10, respectively, thereby disposing the insulating sheet 25 substantially coaxially with the electrode group 10.

According to this, the main body portion 21a of the conductive lead 21 and the main body portion 22a of the conductive lead 22 are disposed, respectively within the opening 25a of the insulating sheet 25, and substantially the entirety of each of the upper and lower surfaces of the electrode group 10 is covered by the insulating sheet 25, exclusive of a region corresponding to the opening 25a.

Subsequently, as illustrated in FIG. 9, the conductive lead 21 and the conductive lead 22 are respectively bent toward the outer periphery side of the electrode group 10 in the root portions of the main body portions 21a and 22a, respectively. In addition, the conductive lead 21 and the conductive lead 22 are further bent toward the axial center side of the electrode group 10 in the vicinity of the outer peripheries of the spiral shape portions 21b and 22b, respectively. According to this, the end portion 22c for welding of the conductive lead 22 is disposed coaxially with the axial core 15 of the electrode group 10. In addition, the end portion 21c for welding of the conductive lead 21 is disposed outside the radial direction of the hollow portion 15a of the axial core 15 of the electrode group 10. In this way, as illustrated in FIG. 2, the electrode group 10 in which the spiral shape portions 21b and 22b have the conductive leads 21 and 22 protruding from the upper surface side and the lower surface side, respectively, and the upper surface side and the lower surface side are covered by the insulating sheet 25.

[Fabrication of Battery can]

On the other hand, as illustrated in FIG. 1, the headless, closed-end battery can 2 having the opening 202 is fabricated. The outer and inner surfaces of the battery can 2 are entirely plated.

[Accommodation into Battery Container]

Subsequently, the electrode group 10 is accommodated within the battery can 2.

### [Joining of Negative Electrode]

Then, as illustrated in FIG. 10, the electrode rod 61 is inserted into the hollow portion 15a of the axial core 15. The end portion 22c for welding of the conductive lead 22 is welded to the can bottom 203 of the battery can 2. The electrode rod 61 generally has a radius of from 1 to 5 mm, and an area of the end portion 22c for welding is desirably larger than an area of the electrode rod 61. According to this, a size of the welded portion between the end portion 22c for welding of the conductive lead 22 and the can bottom 203 of the battery can 2 is from about 1 to 5 mm in terms of a radius. In that case, the size of the welded portion is more preferably from about 3 to 5 mm in terms of a radius.

Subsequently, a part of the upper end side of the battery can 2 is protruded inward upon being subjected to drawing processing, thereby forming the groove 201 that is a substantially U-shaped.

### [Injection of Electrolytic Solution]

Subsequently, a prescribed amount of a nonaqueous electrolytic solution is injected into the interior of the battery can 2 having the electrode rod 10 accommodated therein. The nonaqueous electrolytic solution is injected from the hollow portion 15a of the upper end of the axial core 15. As described above, for example, a solution of a lithium salt dissolved in a carbonate-based solvent is used as the nonaqueous electrolytic solution.

### [Fabrication of Lid Unit]

On the other hand, separately from the above-described assembling process, the lid unit 5 is fabricated.

As described above, the lid unit 5 is configured of the insulating plate 34, the collector plate 27 fitted in the opening 34a of the insulating plate 34, the connection plate 35, the diaphragm 37 welded to the connection plate 35, and the lid body 3 fixed to the diaphragm 37 by means of caulking. The fabrication method of the lid unit 5 is as described previously.

### [Joining of Positive Electrode]

The electrode group 10 and the lid unit 5 are electrically connected to each other. First of all, the seal member 43 is placed on the groove 201 of the battery can 2. As illustrated in FIG. 2, the seal member 43 in this state has a structure having, in an upper portion of the annular base portion 43a, the outer peripheral wall portion 43b that is vertical to the base portion 43a.

Subsequently, on the base portion 43a of the seal member 43, the lid unit 5 is placed in an inclined state. This may be done in such a manner that in a state where the lid unit 5 is made substantially vertical, apart of the outer periphery thereof is placed on the base portion 43a of the seal member 43, and the opposite side of the outer periphery of the lid unit 5 is inclined toward the side of the battery can 2 at an appropriate angle. In this state, the end portion 21c for welding of the conductive lead 21 is welded to the lower surface of the collector plate 27 of the lid unit 5.

### [Sealing]

After completion of welding between the collector plate 27 and the conductive lead 21, the lid unit is flattened substantially horizontally, thereby bringing the entirety of the lower surface of the peripheral portion of the diaphragm 27 into contact with the base portion 43a of the seal member 43. In this state, the battery can 2 and the battery unit 5 are subjected to caulking processing to achieve sealing, followed by hermetically sealing from the exterior. There is thus obtained the cylindrical secondary battery 1 illustrated in FIG. 1.

### (Confirmation of Effects)

For the purpose of confirming the effects of the invention, a torsion test and a vibration test were carried out using the cylindrical secondary battery according to the invention and a cylindrical secondary battery of Comparative example.

For the torsion test and the vibration test, a sample obtained by fabricating the cylindrical secondary battery 1 and then subjecting it to a prescribed aging process was used.

The torsion test was carried out in such a manner that in the cylindrical secondary battery 1, charge and discharge of 3 C rate was repeated 100 times in the range of from 0% of SOC to 100% of SOC (from 2.8 V to 4.2 V), and a force derived due to the increase or decrease of volume of the active material was applied to the electrode group 10.

The vibration test was carried out in such a manner that the cylindrical secondary battery 1 was repeatedly vibrated in the axial direction of the cylinder can in a vibration width of 10 mm at a frequency of 100 Hz for 24 hours, and a force of the axial direction was applied to the electrode group 10.

The evaluation of each of the torsion test and the vibration test was carried out in such a manner that after the test, the cylindrical secondary battery 1 was taken apart, and the presence or absence of breakage of the welded portion was confirmed by visual inspection.

Incidentally, the term “SOC” means the state of charge, and 0% of SOC is in a state of complete discharge, whereas 100% of SOC is in a state of full charge. In addition, the term “C” means a unit of the charge and discharge current, and 1 C expresses a current at which the battery capacity can be charged or discharged within one hour.

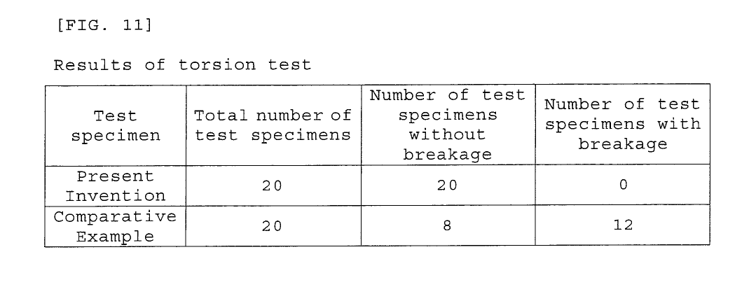

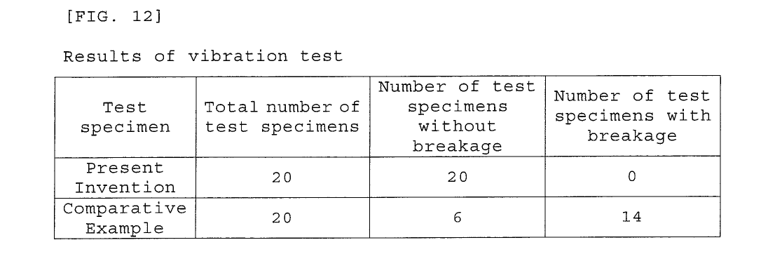

FIG. 11 shows results of the torsion test, and FIG. 12 shows results of the vibration test.

In each of the tests, a sample obtained by bending a tape-shaped conductive foil in a zigzag form and welding the positive electrode sheet 11a to the lid unit 5 and the negative electrode sheet 12a to the can bottom 203 of the battery can 2, respectively was used as the Comparative Example.

According to the results of the torsion test shown in FIG. 11, in the Comparative Example, the breakage was observed in 12 of the 20 test specimens, whereas in the conductive leads 21 and 22 of the above-described embodiment, the generation of breakage was not observed at all.

In addition, according to the results of the vibration test shown in FIG. 12, in the Comparative Example, the breakage was observed in 14 of the 20 test specimens, whereas in the conductive leads 21 and 22 of the above-described embodiment, the generation of breakage was not observed at all.

In the light of the above, in all of the torsion test and the vibration test, the effects of the above-described embodiment were perceived.

### Embodiment 2

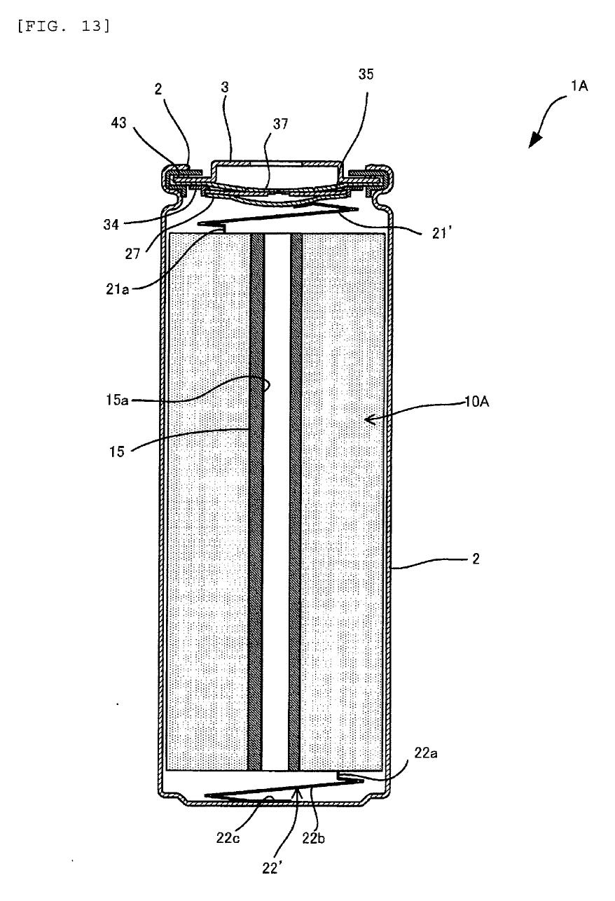

FIG. 13 is a cross-sectional view of Embodiment 2 of the cylindrical secondary battery according to the invention.

A difference of a cylindrical secondary battery 1A of Embodiment 2 from the cylindrical secondary battery 1 of Embodiment 1 resides in a point in which each of the main body portion 21a of a conductive lead 21′ of the positive electrode side and the main body portion 22a of a conductive lead 22′ of the negative electrode side of the electrode group 10A is positioned substantially in the center of the radial direction of the electrode group 10.

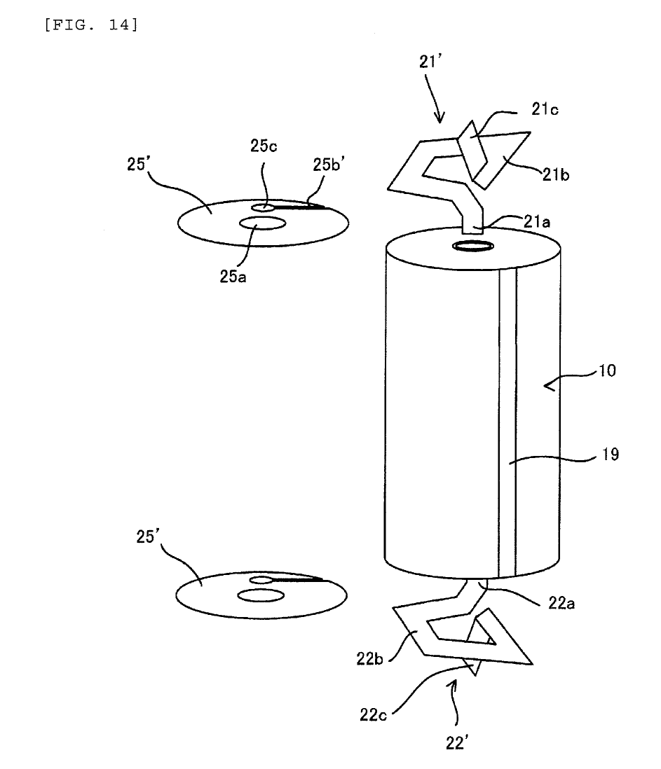

FIG. 14 is a perspective view of the electrode group 10A.

As illustrated in FIG. 14, in the conductive lead 21′ of the positive electrode side, the main body portion 21a protrudes toward the upper surface side from the intermediate portion in the radial direction of the electrode group 10A. In addition, in the conductive lead 22′ of the negative electrode side, the main body portion 22a protrudes toward the lower surface side from the intermediate portion in the radial direction of the electrode group 10A.

An insulating sheet 25′ has the opening 25a corresponding to the axial core 15 and an opening 25c in which the main body portion 21a or 22a of the conductive lead 21 or 22 is disposed. A slit 25b′ for inserting the main body portion 21a or 22a of the conductive lead 21 or 22 into the opening 25c is provided upon being extended to the outer periphery from the opening 25c.

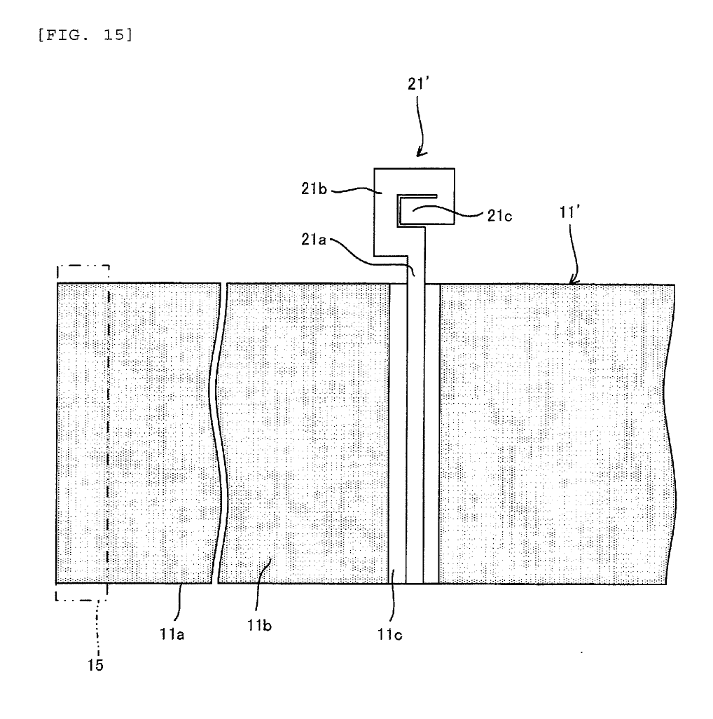

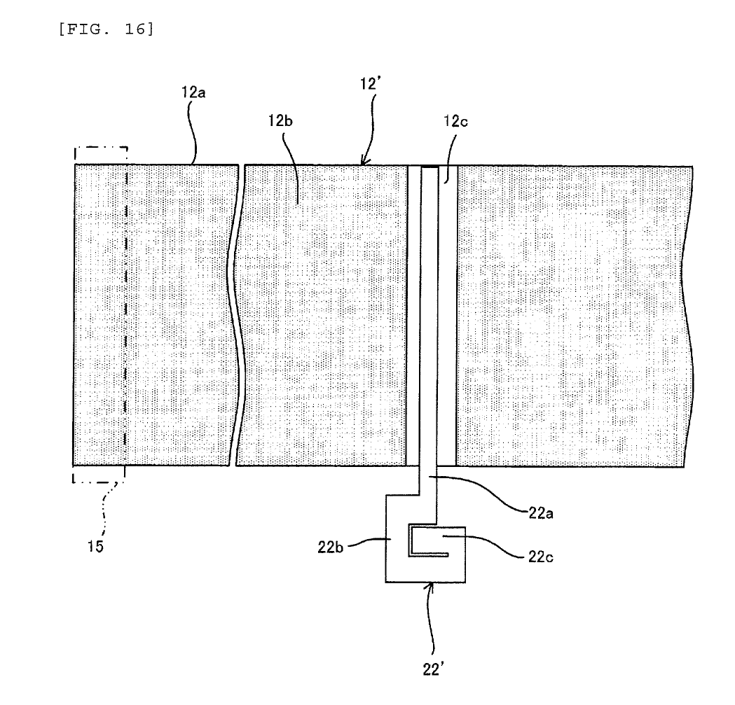

FIG. 15 is a plan view showing a joining state between a positive electrode 11′ and the conductive lead 21′, and FIG. 16 is a plan view showing a joining state between a negative electrode 12′ and the conductive lead 22′.

In the positive electrode 11′, the positive electrode mixture-untreated portion 11c in which the positive electrode mixture 11b is not coated is provided in an intermediate portion in the longer direction of the longitudinal positive electrode sheet 11a. The conductive lead 21′ is welded to the positive electrode mixture-untreated portion 11c at this position.

In addition, in the negative electrode 12′, the negative electrode mixture-untreated portion 12c in which the negative electrode mixture 12b is not coated is provided in an intermediate portion in the longer direction of the longitudinal negative electrode sheet 12a. The conductive lead 22′ is welded to the negative electrode mixture-untreated portion 12c at this position.

Similar to the case of Embodiment 1, each of the positive electrode 11′ and the negative electrode 12′, to which the conductive leads 21′ and 22′ are welded, respectively, is wound around the outer periphery of the axial core 15 from the side edge of the tip side via the first and second separators 13 and 14.

Since other configurations of Embodiment 2 are the same as those of Embodiment 1, the same reference numbers are given to the corresponding members, and explanations thereof are omitted.

Even in such cylindrical secondary battery 1A shown in Embodiment 2, the same effects as those in the case of Embodiment 1 are brought.

According to the above-described embodiments, the following effects are brought.

(1) Each of the conductive leads 22 and 22′ has the end portion 22c for welding extended to a position corresponding to the hollow portion 15a of the axial core 15 in the tip of the spiral shape portion 22b. Accordingly, it becomes possible to insert the electrode rod 61 from the hollow portion 15a of the axial core 15 in a state of accommodating the electrode group 10 or 10A within the battery can 2 and weld the end portion 22c for welding to the can bottom 203 of the battery can 2, so that the assembling workability is enhanced.

(2) Each of the conductive leads 21 and 21′ of the positive electrode side and each of the conductive leads 22 and 22′ of the negative electrode side have the spiral shape portions 21b and 22b, respectively. Since the spiral shape portion 21b or 22b is deformed in the axial center direction and the radial direction, the torsion of the electrode group 10 and the external force which is applied to the welded portion following the movement in the axial direction are reduced. According to this, the breakage of the welded portion can be prevented.

(3) Each of the conductive leads 21 and 21′ of the positive electrode side and each of the conductive leads 22 and 22′ of the negative electrode side have a spiral shape which does not have portions overlapping each other in the planar view. Accordingly, each of the conductive leads 21, 21′, 22 and 22′ can be formed by means of pressing and can be efficiently processed.

(4) Each of the conductive leads 21 and 21′ of the positive electrode side and each of the conductive leads 22 and 22′ of the negative electrode side have the spiral shape portions 21b and 22b, respectively having substantially the same outer diameter as an outer diameter of the electrode group 10. In the case where the tape-shaped conductive lead is bent and welded to the lid unit 5 or the can bottom 203 of the battery can 2, the bent portions comes into contact with the inner surface of the battery can 2 to generate an internal short circuit. However, according to the present embodiments, it is possible to prevent such generation of an internal short circuit to be caused due to the contact of each of the conductive leads 21, 21′, 22 and 22′ with the inner surface of the battery can 2.

Incidentally, in the above-described embodiments, though the spiral shape of each of the conductive leads 21, 21′, 22 and 22′ was made rectangular in the planar view, it can also be made circular or oval.

In addition, in the above-described embodiments, though the number of turn of each of the conductive leads 21, 21′, 22 and 22′ is substantially one, the number of turn may be further increased.

In the above-described embodiments, both of the welding positions of the conductive leads 21 and 22 were the same position of the side edge on the winding start side or the intermediate portion of the positive electrode sheet 11a or the negative electrode sheet 12a. However, the welding positions of the conductive leads 21 and 22 may be welded to the positive electrode sheet 11a and the negative electrode sheet 12a at a different position from each other between the positive electrode side and the negative electrode side by, for example, welding the conductive lead 21 of the positive electrode side to the winding start side of the positive electrode sheet 11a and welding the conductive lead 22 of the negative electrode side to the intermediate portion of the negative electrode sheet 12a. In that case, the welding position of each of the conductive leads 21 and 22 in the intermediate portion may be a different distance from the side edge of the winding start side of the positive electrode sheet 11a or the negative electrode sheet 12a. In that case, the welding position of the conductive lead 21 or 22 may be an end of a winding end side of the positive electrode sheet 11a or the negative electrode sheet 12a.

In the above-described embodiments, the conductive leads 21 of the positive electrode side and the conductive leads 22 of the negative electrode side had a spiral shape which does not have portions overlapping each other in the planar view.

However, the invention is not limited thereto, and the shape may be a spiral shape or a helical shape which has portions overlapping each other in the planar view, or the like. In short, the shape may be a shape capable of being deformed in the axial direction and the radial direction.

In the above-described embodiments, the positive electrode 11 was welded to the lid unit 5, and the negative electrode 12 was welded to the can bottom 203 of the battery can 2. However, the invention is also applicable to a cylindrical secondary battery in which the positive electrode 11 is welded to the can bottom 203 of the battery can 2, and the negative electrode 12 is welded to the lid unit 5.

In the above-described embodiments, the lid unit 5 was configured of the lid body 3, the diaphragm 37, the insulating plate 34, the connection plate 35, and the collector plate 27. However, the configuration of the lid unit 5 is an example, and configurations composed of other members may also be adopted. In addition, the lid member may be made of a single body but not a unitized body, and it may be an electrode terminal member having a function as an electrode terminal.

The above-described embodiments have been described by reference to the lithium ion cylindrical secondary battery as the battery. However, it should not be construed that the invention is limited to the lithium battery, but the invention can also be applied to other cylindrical secondary batteries such as a nickel-hydrogen battery, a nickel-cadmium battery.

Besides, it is possible to configure the cylindrical secondary battery according to the invention upon being deformed in various ways within the range of the gist of the invention. In short, the cylindrical secondary battery may be a cylindrical secondary battery in which an electrode group having a positive electrode and a negative electrode wound around the periphery of an axial core having a hollow portion via a separator is accommodated in a battery can, and one of a conductive lead welded to the negative electrode and a conductive lead welded to the positive electrode is connected to a lid member covering an opening of the battery can, with the other being welded to a can bottom of the battery can, wherein at least the conductive lead welded to the can bottom of the battery can includes an end portion for welding which is extended to a position corresponding to a central portion of the hollow portion of the axial core and a routing portion which is deformable in the axial direction of the axial core and the perpendicular direction to the axial direction, and the end portion for welding is welded to the can bottom of the battery can.

### REFERENCE SIGNS LIST

1, 1A: Cylindrical secondary battery
2: Battery can
203: Can bottom
3: Lid body
5: Lid unit
10, 10A: Electrode group
21, 22: Conductive lead
21b, 22b: Spiral shape portion (routing portion)

1. A cylindrical secondary battery in which an electrode group having a positive electrode and a negative electrode wound around the periphery of an axial core having a hollow portion via a separator is accommodated in a battery can, and one of a conductive lead welded to the negative electrode and a conductive lead welded to the positive electrode is connected to a lid member covering an opening of the battery can, with the other being welded to a can bottom of the battery can, wherein
at least the conductive lead welded to the can bottom of the battery can includes an end portion for welding which is extended to a position corresponding to a central portion of the hollow portion of the axial core and a routing portion which is deformable in the axial direction of the axial core and the perpendicular direction to the axial direction, and the end portion for welding is welded to the can bottom of the battery can.

2. The cylindrical secondary battery according to claim 1, wherein the routing portion of the conductive lead is routed around the periphery of the end portion for welding from the end portion for welding so as not to overlap planarly.

3. The cylindrical secondary battery according to claim 2, wherein the conductive lead includes a bending portion for bending the routing portion toward the outer periphery side in at least one place between the end portion for welding and the routing portion.

4. The cylindrical secondary battery according to claim 1, wherein the routing portion of the conductive lead is in a spiral shape.

5. The cylindrical secondary battery according to claim 1, wherein the conductive lead welded to the can bottom of the battery can is welded to the positive electrode or the negative electrode in a side edge on the winding start side of the axial core of the positive electrode or the negative electrode.

6. The cylindrical secondary battery according to claim 5, further including an insulating sheet disposed between the conductive lead and the can bottom of the battery can, the insulating sheet including a slit for inserting thereinto an opening corresponding to the hollow portion of the axial core and the conductive lead of the axial core.

7. The cylindrical secondary battery according to claim 1, wherein the conductive lead including the end portion for welding welded to the can bottom of the battery can is welded to the positive electrode or the negative electrode in an intermediate portion in the lengthwise direction in the positive electrode or the negative electrode.

8. The cylindrical secondary battery according to claim 7, further including an insulating sheet disposed between the conductive lead and the can bottom of the battery can, the insulating sheet including a first opening provided at a position corresponding to the hollow portion of the axial core, a second opening provided at a position corresponding to a root of the conductive lead in which the conductive lead is welded to the positive electrode or the negative electrode, and a slit for inserting thereinto the conductive lead which is lead out from the second opening into the outside.

9. The cylindrical secondary battery according to claim 8, wherein all of the conductive leads include a routing portion which is deformable in the axial direction of the axial core and the perpendicular direction to the axial direction.

10. The cylindrical secondary battery according to claim 1, wherein a welded portion between the end portion for welding and the can bottom of the battery can has a size of from 1 to 5 mm in terms of a radius.
